(19) United States
(12) Patent Application Publication
(10) Pub. No.: US 2024/0313329 A1
(43) Pub. Date: Sep. 19, 2024

(54) BATTERY MODULE

(71) Applicant: TOYOTA JIDOSHA KABUSHIKI KAISHA, Toyota-shi (JP)

(72) Inventors: Akinori SAITO, Kariya-shi (JP); Shinji SUZUKI, Kariya-shi (JP); Yuya SATO, Kariya-shi (JP)

(73) Assignee: TOYOTA JIDOSHA KABUSHIKI KAISHA, Toyota-shi (JP)

(21) Appl. No.: 18/591,566

(22) Filed: Feb. 29, 2024

(30) Foreign Application Priority Data
Mar. 13, 2023 (JP) 2023-038773

(51) Int. Cl. H01M 50/262; H01M 50/209; H01M 50/289

(52) U.S. Cl. CPC H01M 50/262; H01M 50/209; H01M 50/289

(57) ABSTRACT

A main object of the present disclosure is to provide a battery module of which uniformity of restraining pressure applied to the battery is high. The present disclosure achieves the object by providing a battery module including: a battery including a plurality of electrode layered in a first direction; a pair of elastic member arranged on both surfaces of the battery; a pair of plate member arranged to sandwich the battery and the pair of elastic member in the first direction; a restraining member that applies a restraining pressure to the battery, the pair of elastic member and the pair of plate member in the first direction, and is arranged to face to each other in a second direction orthogonal to the first direction; wherein a specified plate member is included.

### TECHNICAL FIELD

The present disclosure relates to a battery module.

### BACKGROUND ART

As plate members arranged on both surfaces of a battery, a plate member in which a plurality of members are layered, has been known. For example, Patent Literature 1 discloses an end plate having a three layer structure including layers in the order of a first metal plate layer/a resin layer/a second metal plate layer, and an end plate having a four layer structure including layers in the order of a first metal plate layer/a resin layer/a second metal plate layer/a carbon fiber reinforced plastic plate layer.

### CITATION LIST

### Patent Literature

Patent Literature 1: Japanese Patent Application Laid-Open (JP-A) No. 2020-047573

### SUMMARY OF DISCLOSURE

### Technical Problem

For example, as in Patent Literature 1, when a metal plate is combined with a resin plate to configure a plate member, weight reduction of the plate member can be achieved. On the other hand, in the case of a plate member in which a plurality of members are layered, it is necessary for the layered members to be sufficiently fixed. If the fixation is insufficient, when the plate member is deflected to restrain a battery with a restraining member, members adjacent to each other in the plate member may be shifted in a shearing direction (direction orthogonal to a thickness direction).

When the members adjacent to each other in the plate member are shifted to the shearing direction, there will be a region where the restraining pressure applied by the restraining member is sufficient, and a region where the restraining pressure is insufficient, and the restraining pressure to be applied to the battery will be nonuniform. In particular, when a battery is large-scaled, since a deflection amount of the plate member caused by the restraining member is large, the restraining pressure to be applied to the battery tends to be nonuniform.

The present disclosure has been made in view of the above circumstances, and a main object thereof is to provide a battery module of which uniformity of restraining pressure applied to the battery is high.

### Solution to Problem

[1]

A battery module comprising:
a battery including a plurality of electrode layered in a first direction;
a pair of elastic member arranged on both surfaces of the battery;
a pair of plate member arranged to sandwich the battery and the pair of elastic member in the first direction; and
a restraining member that applies a restraining pressure to the battery, the pair of elastic member and the pair of plate member in the first direction, and a pair of the restraining member is arranged to face to each other in a second direction orthogonal to the first direction, wherein
the plate member includes a plurality of core member extending to the second direction, and a first plate member arranged on a surface of the plurality of core member that is the battery side; in the plate member, the core member and the first plate member include a penetration hole extending to the first direction, and the core member and the first plate member are fastened in the first direction by a first fastening member arranged in the penetration hole; and
when viewed from the first direction, the plate member includes a first fixing member that: is arranged in inner side than the outer periphery of the core member; limits relative movement of the core member and the first plate member to the second direction; and does not fasten the core member and the first plate member in the first direction.
   [2]

A battery module comprising:
a battery including a plurality of electrode layered in a first direction;
a pair of elastic member arranged on both surfaces of the battery;
a pair of plate member arranged to sandwich the battery and the pair of elastic member in the first direction; and
a restraining member that applies a restraining pressure to the battery, the pair of elastic member and the pair of plate member in the first direction, and a pair of the restraining member is arranged to face to each other in a second direction orthogonal to the first direction, wherein
the plate member includes a plurality of core member extending to the second direction, and a first plate member arranged on a surface of the plurality of core member that is the battery side;
in the plate member, the core member and the first plate member include a penetration hole extending to the first direction, and the core member and the first plate member are fastened in the first direction by a first fastening member arranged in the penetration hole;
when viewed from the first direction, the plate member includes a first fixing member that: is arranged in inner side than the outer periphery of the core member; and limits relative movement of the core member and the first plate member to the second direction; and
the first fixing member has higher strength in the second direction compared to that of the first fastening member.
   [3]

A battery module comprising:
a battery including a plurality of electrode layered in a first direction;
a pair of elastic member arranged on both surfaces of the battery;
a pair of plate member arranged to sandwich the battery and the pair of elastic member in the first direction; and
a restraining member that applies a restraining pressure to the battery, the pair of elastic member and the pair of plate member in the first direction, and a pair of the restraining member is arranged to face to each other in a second direction orthogonal to the first direction, wherein
the plate member includes a plurality of core member extending to the second direction, and a first plate member arranged on a surface of the plurality of core member that is the battery side;
in the plate member, the core member and the first plate member include a penetration hole extending to the first direction, and the core member and the first plate member are fastened in the first direction by a first fastening member arranged in the penetration hole;
when viewed from the first direction, the plate member includes a first fixing member that: is arranged in inner side than the outer periphery of the core member; and limits relative movement of the core member and the first plate member to the second direction; and
a clearance between the first fixing member and a side surface of a hole part formed in the core member and the first plate member in the second direction is smaller than a clearance between the first fastening member and a side surface of the penetration hole in the second direction.
   [4]

The battery module according to any one of [1] to [3], wherein the first fixing member is arranged to overlap with a boundary between the core member and the first plate member when viewed from the second direction.

[5]

The battery module according to any one of [1] to [4], wherein the first fixing member fits each of a hole part formed in the core member and a hole part formed in the first plate member to limit relative movement of the core member and the first plate member to the second direction.

[6]

The battery module according to any one of [1] to [5], wherein
the plate member includes a second plate member arranged on a surface of the plurality of core member that is opposite side to the battery;
in the plate member, the core member and the second plate member include a penetration hole extending to the first direction, and the core member and the second plate member are fastened in the first direction by a second fastening member arranged in the penetration hole; and
when viewed from the first direction, the plate member includes a second fixing member that: is arranged in inner side than the outer periphery of the core member; limits relative movement of the core member and the second plate member to the second direction; and does not fasten the core member and the second plate member in the first direction.
   [7]

The battery module according to any one of [1] to [6], wherein the first fixing member is arranged in outer side than the first fastening member arranged in a position farthest from a center of the core member in the second direction, when viewed from the first direction.

[8]

The battery module according to any one of [1] to [7], wherein a first fixing member is respectively arranged at both ends of one of the core member in the second direction.

[9]

The battery module according to any one of [1] to [8], wherein the core member is a hollow member including a hollow part extending to the second direction.

[10]

The battery module according to any one of [1] to [9], wherein a shape of an outer periphery of the core member when viewed from the second direction is a square.

[11]

The battery module according to any one of [1] to [10], wherein, in the plate member, the core members adjacent to each other are arranged interposing a space in a third direction orthogonal to the first direction and the second direction.

[12]

The battery module according to any one of [1] to [11], wherein a shape of the battery when viewed from the first direction is a square, and a length of each side configuring the square is 20 cm or more. [13]

The battery module according to any one of [1] to [12], wherein the restraining pressure to be applied by the restraining member is 10 kN or more and 500 kN or less.

### Advantageous Effects of Disclosure

The battery module in the present disclosure exhibits an effect that uniformity of restraining pressure applied to the battery is high.

### BRIEF DESCRIPTION OF DRAWINGS

FIGS. 1A to 1C are schematic cross-sectional views exemplifying the battery module in the present disclosure.

FIGS. 2A to 2C are schematic perspective views and a schematic cross-sectional view exemplifying the plate member in the present disclosure.

FIGS. 3A and 3B are schematic cross-sectional views exemplifying the problem in the present disclosure.

FIG. 4 is an enlarged view of region Z in FIG. 3B.

FIG. 5 is a schematic cross-sectional view exemplifying the fixing member in the present disclosure.

FIGS. 6A and 6B are schematic side views exemplifying the plate member in the present disclosure.

FIGS. 7A to 7C are schematic side views exemplifying the plate member in the present disclosure.

FIGS. 8A to 8C are a schematic plan view and schematic cross-sectional views exemplifying the fastening member and the fixing member in the present disclosure.

FIGS. 9A and 9B are schematic cross-sectional views exemplifying the fastening member in the present disclosure.

FIGS. 10A to 10C are schematic cross-sectional views exemplifying the fixing member in the present disclosure.

FIGS. 11A to 11E are schematic plan views exemplifying the fastening member and the fixing member in the present disclosure.

FIG. 12 is a schematic plan view exemplifying the battery in the present disclosure.

FIGS. 13A and 13B are schematic cross-sectional views exemplifying the battery in the present disclosure.

FIG. 14 is a schematic cross-sectional view exemplifying the method for producing a battery in the present disclosure.

FIGS. 15A and 15B are a schematic plan view and a schematic side view exemplifying the restraining member in the present disclosure.

FIG. 16 is a schematic cross-sectional view exemplifying the plate member in the present disclosure.

FIGS. 17A to 17C are schematic cross-sectional views exemplifying the fixing member and the fastening member in the present disclosure.

### DESCRIPTION OF EMBODIMENTS

The embodiments in the present disclosure will be hereinafter explained in details with reference to drawings. Each drawing described as below is a schematic view, and the size and the shape of each portion are appropriately exaggerated in order to be understood easily. Furthermore, in the present description, upon expressing an embodiment of arranging one member with respect to the other member, when it is expressed simply “on” or “below”, both of when the other member is directly arranged on or below the one member so as to contact with each other, and when the other member is arranged above or below the one member interposing an additional member, can be included unless otherwise described.

### A. First Embodiment

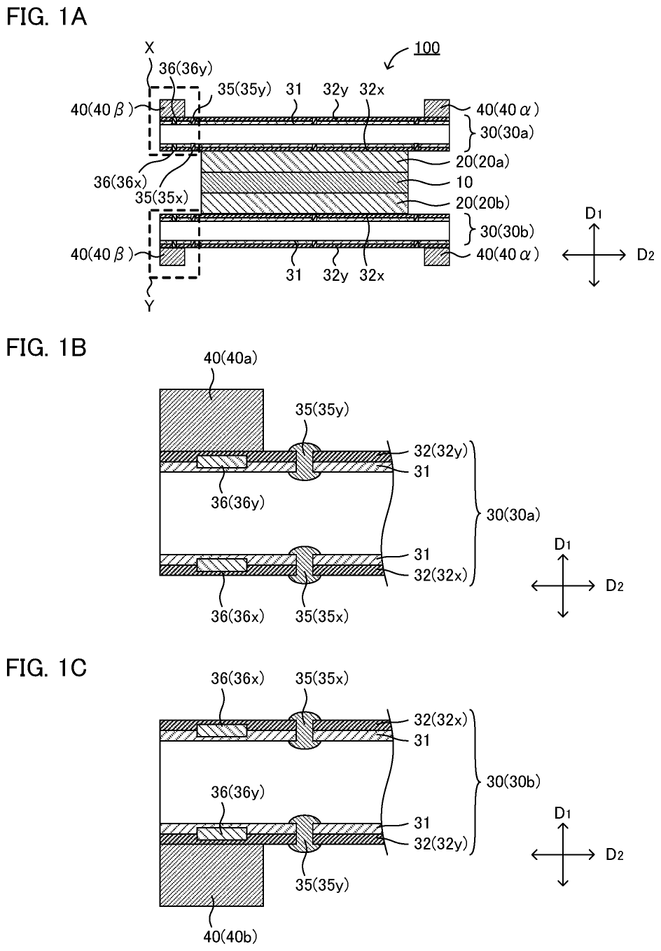

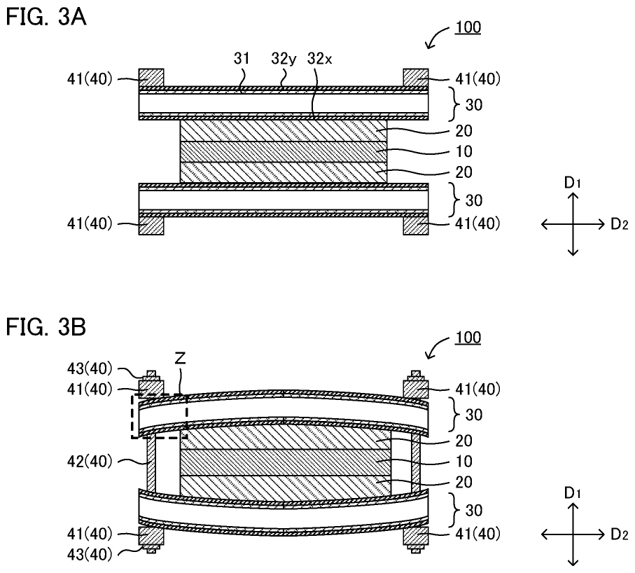

FIG. 1A is a schematic cross-sectional view exemplifying the battery module in the first embodiment, FIG. 1B is an enlarged view of region X in FIG. 1A, and FIG. 1C is an enlarged view of region Y in FIG. 1A. As shown in FIG. 1A, battery module 100 includes battery 10, a pair of elastic member 20 (elastic member 20a and elastic member 20b) arranged on both surfaces of the battery 10, a pair of plate member 30 (plate member 30a and plate member 30b) arranged to sandwich the battery 10 and the pair of elastic member 20 in the first direction D₁, and restraining member 40 that applies a restraining pressure to the battery 10, the pair of elastic member 20 and the pair of plate member 30 in the first direction D₁, and a pair of the restraining member 40 (restraining member 40α and restraining member 40β) is arranged to face to each other in a second direction D₂ orthogonal to the first direction D₁. Incidentally, FIGS. 1A to 1C show a status where a restraining pressure is not applied to the battery 10 by the restraining member 40, unlike FIG. 3B described later.

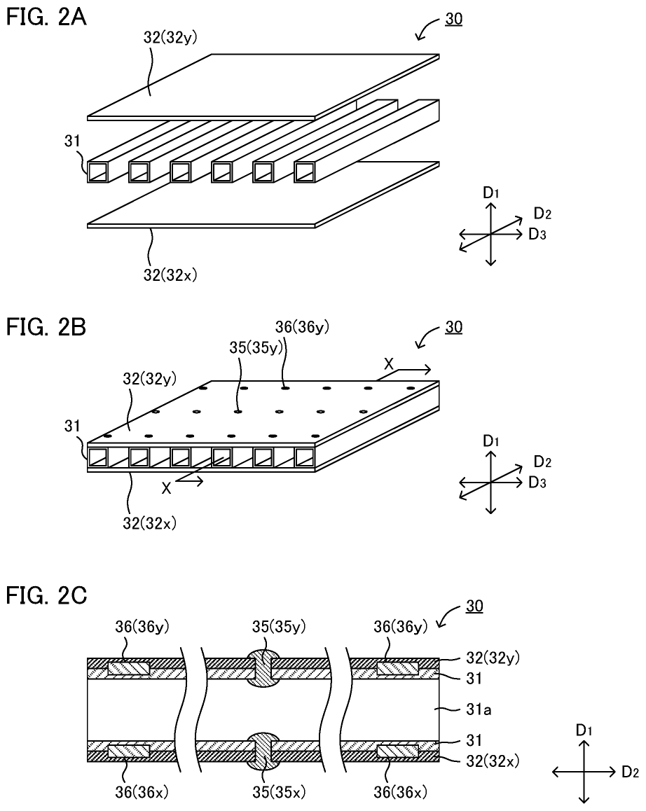

FIG. 2A is a schematic perspective view (exploded view) exemplifying the plate member in the first embodiment, FIG. 2B is a schematic perspective view exemplifying the plate member in the first embodiment, and FIG. 2C is a schematic cross-sectional view of the plate member in a plane D₁-D₂, including X-X line shown in FIG. 2B. Incidentally, fixing member 36y in FIG. 2C is covered with plate member 32y, but in FIG. 2B, the fixing member 36y is shown on the plate member 32y for convenience.

As shown in FIGS. 2A to 2C, plate member 30 includes a plurality of core member 31 extending to the second direction D₂, and plate member 32 (first plate member 32x, second plate member 32y) arranged respectively on both surfaces of the core member 31. Also, in the plate member 30, the core member 31 and the plate member 32 include a penetration hole extending to the first direction D₁, and the core member 31 and the plate member 32 are fastened in the first direction D₁ by fastening member 35 arranged in the penetration hole. Also, when viewed from the first direction D₁, the plate member 30 includes fixing member 36 that: is arranged in inner side than the outer periphery of the core member 31; limits relative movement of the core member 31 and the plate member 32 to the second direction D₂; and does not fasten the core member 31 and the plate member 32 in the first direction D₁.

According to the first embodiment, the fixing member is arranged on the plate member including the core member and the plate member, and thus a battery module may have high uniformity of the restraining pressure applied to the battery. Here, FIG. 3A shows a status where a restraining pressure is not applied to the battery 10 by the restraining member 40, and FIG. 3B shows a status where a restraining pressure is applied to the battery 10 by the restraining member 40. In specific, the restraining member 40 includes a pair of restraining plate 41, connecting member 42 that connects the pair of restraining member 41, adjusting member 43 that is connected to the connecting member 42 and adjusts a distance between the pair of restraining plate 41, and a restraining pressure is applied to the battery 10 by the pair of restraining plate 41, the connecting member 42, and the adjusting member 43. As shown in FIG. 3B, the plate member 30 may be deflected using the restraining member 40, to apply a restraining pressure to the battery 10. It is necessary that the core member 31 and the plate member 32 configuring the plate member 30 are sufficiently fixed.

As a method for fixing the core member 31 and the plate member 32, for example, welding is considered. If welding is performed, although the core member 31 and the plate member 32 are strongly fixed, welding deflection (deflection by heat contraction at the time of welding) may derive a wave on the surface of the plate member 32, and uniformity of the restraining pressure applied to the battery may be decreased. To remove the wave, for example, mechanical processing is necessary, and productivity may be degraded. In particular, when the battery is large-scaled, the plate member is also large-scaled, and thus the area in which the wave should be removed will also increase, and the degrade of productivity will be remarkable. In contrast, in the first embodiment, as shown in FIG. 1B, the core member 31 and the plate member 32 are fixed using fastening member 35 (such as a rivet). One of the advantages in using the fastening member 35 is that a wave is not easily caused in the plate member unlike the case of using welding as described above.

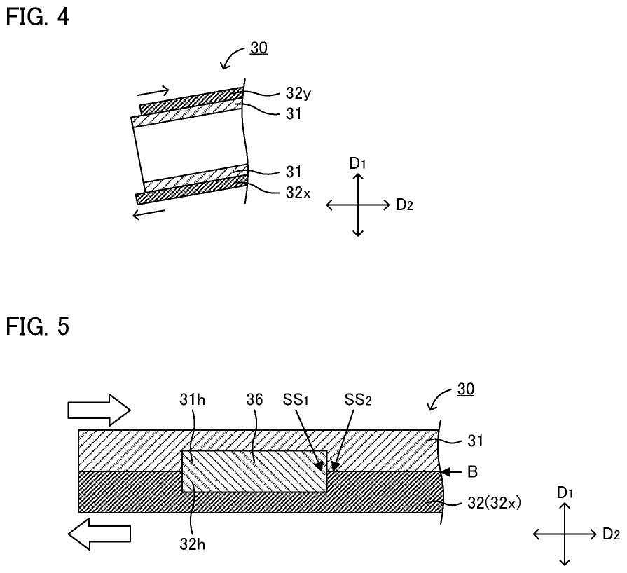

Meanwhile, as shown in FIG. 1B, when the fastening member 35 is used, fixation of the core member 31 and the plate member 32 tends to be insufficient. When the fixation of the core member 31 and the plate member 32 is insufficient, as shown in FIG. 3B and FIG. 4, on the occasion of deflecting the plate member 30, the core member 31 and the plate member 32 may be shifted to a shearing direction (direction orthogonal to a thickness direction). When the core member 31 and the plate member 32 are shifted to the shearing direction, there will be a region where the restraining pressure applied by the restraining member 30 is sufficient, and a region where the restraining pressure is insufficient (or a region where the restraining pressure is not applied at all), and the restraining pressure applied to the battery 10 will be nonuniform. In particular, when a battery is large-scaled, since a deflection amount of the plate member caused by the restraining member is large, the restraining pressure to be applied to the battery tends to be nonuniform.

In contrast, in the first embodiment, as shown in FIG. 5, the fixing member 36 is arranged on the plate member 30 including the core member 31 and the plate member 32, and thus the battery module may have high uniformity of the restraining pressure applied to the battery. In specific, when side surface SS₁ in the fixing member 36 and side surface SS₂ in the core member 31 and the plate member 32 are arranged to face to each other, the fixing member 36 becomes a resistance to the shift to the shearing direction. Thus, the battery module may have high uniformity of restraining pressure applied to the battery. In the first embodiment, unlike the fastening member 35, the fixing member 36 is a member not fastening the core member 31 and the plate member 32 in the first direction D₁.

### 1. Plate Member

The battery module in the first embodiment includes, as shown in FIG. 1A, a pair of plate member 30 (30a, 30b) arranged to sandwich the battery 10 and a pair of elastic member 20 (20a, 20b) in the first direction D₁.

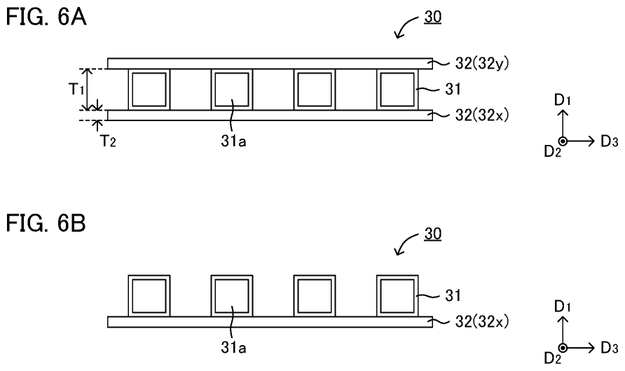

As shown in FIG. 1B and FIG. 6A, the plate member 30 includes a plurality of core member 31 extending to the second direction D₂, and first plate member 32x arranged on a surface of the plurality of core member 31 that is the battery side (down side of the drawing). As shown in FIG. 6A, the plate member 30 may include second plate member 32y arranged on a surface of the plurality of core member 31 that is opposite side to the battery (upper side of the drawing), in addition to the first plate member 32x. Meanwhile, as shown in FIG. 6B, the plate member 30 may not include a plate member on a surface of the plurality of core member 31 that is opposite side to the battery (upper side of the drawing).

### (1) Core Member

As shown in FIG. 1A, the core member 31 is a member extending to the second direction D₂. As shown in FIG. 2A, the plurality of core member 31 is arranged along a third direction D₃ orthogonal to the first direction D₁ and the second direction D₂. Also, as shown in FIG. 2B, the core member 31 and the plate member 32 may contact each other. Meanwhile, although not illustrated in particular, an additional member may be arranged between the core member and the plate member. There are no particular limitations on the material of the core member, and examples thereof may include a metal such as stainless steel and aluminum.

As shown in FIG. 2C, the core member 31 may include hollow part 31a extending to the second direction D₂. When the core member 31 includes the hollow part 31a, weight reduction of the plate member 30 can be achieved. The hollow part 31a preferably extends from one end to the other end of the core member 31 in the second direction D₂. Meanwhile, although not illustrated, the core member may be a member (solid member) not including a hollow part.

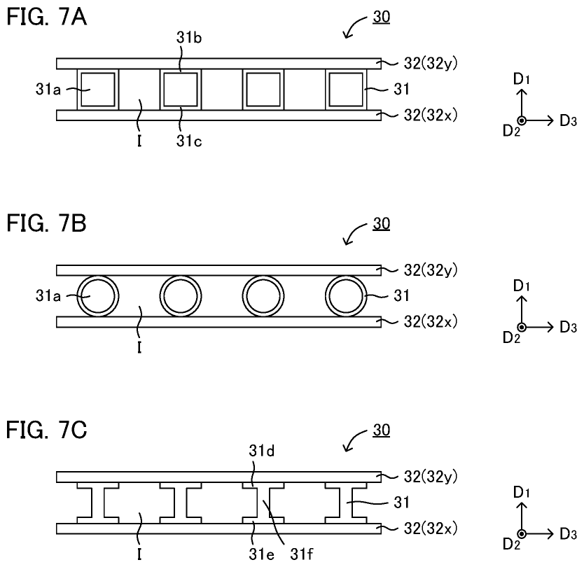

There are no particular limitations on the shape of the outer periphery of the core member viewed from the second direction. For example, as shown in FIG. 7A, the shape of the outer periphery of the core member 31 when viewed from the second direction D₂ may be a square. Examples of the square may include a foursquare and a rectangular. The core member 31 shown in FIG. 7A includes top surface part 31b and bottom surface part 31c extending to the third direction D₃ and facing to each other, when viewed from the second direction D₂. It is preferable that the later described fastening member and fixing member are arranged respectively on the top surface part 31b and the bottom surface part 31c.

Also, as shown in FIG. 7B, when viewed from the second direction D₂, the shape of the outer periphery of the core member 31 may be a circle. Examples of the circle may include a perfect circle and an oval. Also, as shown in FIG. 7C, when viewed from the second direction D₂, the shape of the outer periphery of the core member 31 may be an I shape that includes top surface part 31d extending to the third direction D₃, bottom surface part 31e extending to the third direction D₃, and connecting part 31f extending to the first direction D₁ and connecting the top surface part 31d and the bottom surface part 31e.

As shown in FIGS. 7A to 7C, the core members 31 adjacent to each other may be arranged interposing space I in a third direction D₃ orthogonal to the first direction D₁ and the second direction D₂. When the space I is arranged, weight reduction of the plate member 30 can be achieved. Meanwhile, although not illustrated in particular, the core members adjacent to each other may be arranged without interposing a space. For example, the core members adjacent to each other may contact each other.

### (2) Plate Member

As shown in FIG. 1B and FIG. 6A, the plate member 30 includes at least first plate member 32x arranged on a surface of the plurality of core member 31 that is the battery side (lower side of the drawing). Also, as shown in FIG. 6A, the plate member 30 may include second plate member 32y arranged on a surface of the plurality of core member 31 that is opposite side to the battery (upper side of the drawing), in addition to the first plate member 32x. In the first embodiment, the first plate member and the second plate member may be simply referred to as a plate member. There are no particular limitations on the material of the plate member, and examples thereof may include a metal such as stainless steel and aluminum.

As shown in FIG. 6A, T₁ designates a thickness (length in the first direction D₁) of the core member 31, and T₂ designates a thickness of the plate member 32 (first plate member 32x). The rate of T₂ with respect to T₁, which is T₂/T₁ is not particularly limited, and for example, it is 0.5 or less, may be 0.3 or less, and may be 0.1 or less.

### (3) Fastening Member

As shown in FIG. 1B, the plate member 30 includes first fastening member 35x fastening the core member 31 and the first plate member 32x in the first direction D₁. Similarly, as shown in FIG. 1C, the plate member 30 may include second fastening member 35y fastening the core member 31 and the second plate member 32y in the first direction D₁. In the first embodiment, the first fastening member and the second fastening member may be simply referred to as a fastening member. There are no particular limitations on the material of the fastening member, and examples thereof may include a metal.

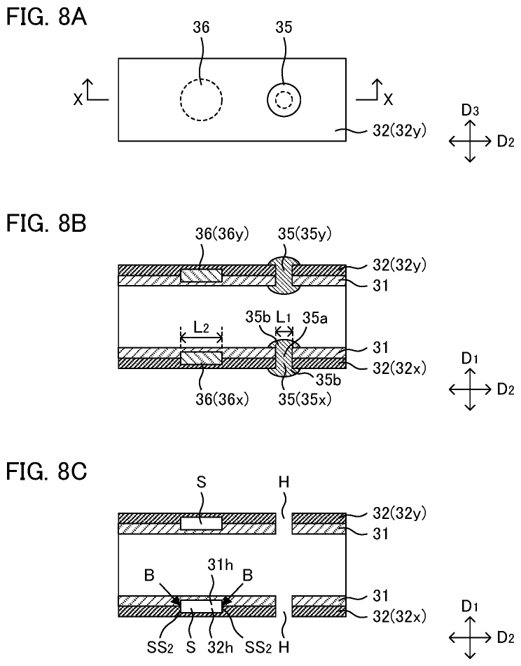

FIG. 8A is a schematic plan view exemplifying the fastening member and the fixing member in the first embodiment, FIG. 8B is a cross-sectional view of X-X in FIG. 8A, and FIG. 8C is a drawing excluding the fastening member and the fixing member from FIG. 8B. As shown in FIG. 8C, the core member 31 and the plate member 32 include penetration hole H extending to the first direction D₁. Also, as shown in FIGS. 8A and 8B, the fastening member 35 is arranged in the penetration hole H in FIG. 8C. Also, the fastening member 35 includes axis part 35a inserted in the penetration hole H, and flange part 35b that is respectively arranged at the both ends of the axis part 35a and has a larger diameter than that of the penetration hole H. Since the diameter of the flange part 35b is larger than the diameter of the penetration hole H, the relative movement of the core member 31 and the plate member 32 in the first direction D₁ is limited. Also, since the fastening member 35 includes the axis part 35a, the relative movement in a direction orthogonal to the first direction D₁ is also limited.

The shape of the fastening member viewed from the first direction is not particularly limited, and examples thereof may include a circle shape such as a perfect circle and an oval. Specific examples of the fastening member may include a rivet.

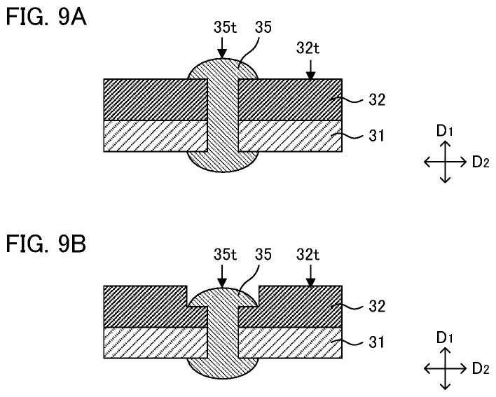

As shown in FIG. 9A, in the first direction D₁, the top 35t of the fastening member 35 may protrude the top 32t of the plate member 32. Meanwhile, as shown in FIG. 9B, in the first direction D₁, the top 35t of the fastening member 35 may not protrude the top 32t of the plate member 32. In FIG. 9B, since the plate member 32 includes a thin wall part “a” around the penetration hole, the top 35t of the fastening member 35 is positioned in the core member 31 side with respect to the top 32t of the plate member 32 in the first direction D₁.

### (4) Fixing Member

As shown in FIG. 1B, the plate member 30 includes first fixing member that: is arranged in inner side than the outer periphery of the core member 31; limits relative movement of the core member 31 and the first plate member 32x to the second direction Da; and does not fasten the core member 31 and the first plate member 32x in the first direction D₁. Similarly, as shown in FIG. 1C, the plate member 30 may include second fixing member that: is arranged in inner side than the outer periphery of the core member 31; limits relative movement of the core member 31 and the second plate member 32y to the second direction D₂; and does not fasten the core member 31 and the second plate member 32y in the first direction D₁. In the first embodiment, the first fixing member and the second fixing member may be simply referred to as a fixing member. There are no particular limitations on the material of the fixing member, and examples thereof may include a metal.

As shown in FIG. 8C, the core member 31 and the plate member 32 include space S configured to store the fixing member. The space S shown in FIG. 8C is configured by hole part 31h formed in the core member 31, and hole part 32h formed in the plate member 32. Also, the core member 31 and the plate member 32 include SS₂ as a side surface facing the space S in the second direction D₂. The side surface SS₂ is a surface including boundary B of the core member 31 and the plate member 32. When the side surface SS₂ is arranged to face to the side surface SS₁ of the fixing member as shown in FIG. 5, the fixing member 36 can be resistance to the shift in the shearing direction. Thus, the battery module may have high uniformity of restraining pressure applied to the battery. Also, as shown in FIG. 5, when viewed from the second direction D₂, the fixing member 36 is preferably arranged in a position overlapping the boundary B of the core member 31 and the plate member 32. The fixing member 36 limits the relative movement of the core member 31 and the first plate member 32 to the second direction D₂, while fitting in the hole part 31h formed in the core member 31 and the hole part 32h formed in the plate member 32.

As shown in FIG. 8B, in the second direction D₂, L₁ designates a length of the axis part 35a of the fastening member 35, and L₂ designates a length of the fixing member 36. The L₂ is preferably larger than the L₁. The rate of the L₂ with respect to the L₁, which is L₂/L₁ is, for example, 1.2 or more, may be 1.5 or more, may be 2 or more, and may be 3 or more. Meanwhile, the L₂/L₁ is, for example, 5 or less.

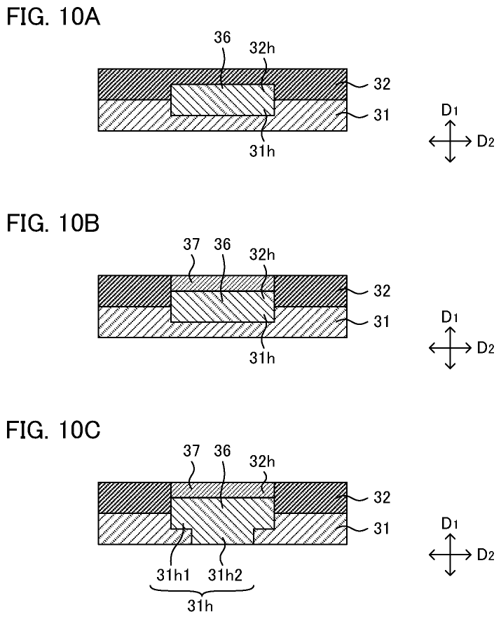

As shown in FIG. 10A, the core member 31 usually includes hole part 31h configured to arrange the fixing member 36. Similarly, the plate member 32 usually includes hole part 32h configured to arrange the fixing member 36. The hole part 31h and the hole part 32h shown in FIG. 10A are a groove part including a bottom. As shown in FIG. 10A, when the core member 31 includes the hole part 31h that is a groove part, and the plate member 32 includes the hole part 32h that is a groove part, the fixing member 36 is arranged in a space configured by the hole part 31h and the hole part 32h before fastening the core member 31 and the plate member 32 by a fastening member (not illustrated).

Meanwhile, as shown in FIG. 10B, the hole part 32h formed in the plate member 32 may be a penetration part. When the hole part 32h is the penetration part, the fixing member 36 is preferably held by holding part 37 arranged in the penetration part. As shown in FIG. 10B, when the core member 31 includes the hole part 31h that is a groove part, and the plate member 32 includes the hole part 32h that is a penetration part, the fixing member 36 is arranged in a space configured by the hole part 31h and the hole part 32h after fastening the core member 31 and the plate member 32 by a fastening member (not illustrated), and then the holding part 37 can be formed. Examples of the material for the holding part 37 may include a resin. Also, although not illustrated in particular, the core member may include a hole part that is a penetration part, and the plate member may include a hole part that is a groove part. Also, as shown in FIG. 10C, the hole part 31h formed in the core member 31 and the hole part 32h formed in the plate member 32 may be respectively a penetration part. The hole part 31h includes, in the order from the plate member 32 side, a large diameter part 31h1 and a small diameter part 31h2 of which diameter is smaller than that of the large diameter part 31h1. Also, the fixing member 36 has a stepped structure that respectively fits the large diameter part 31h1 and the small diameter part 31h2.

The shape of the fixing member viewed from the first direction is not particularly limited, and examples thereof may include a circle shape such as a perfect circle and an oval, and a square shape such as a foursquare and a rectangular. Specific examples of the fixing member may include a solid pin.

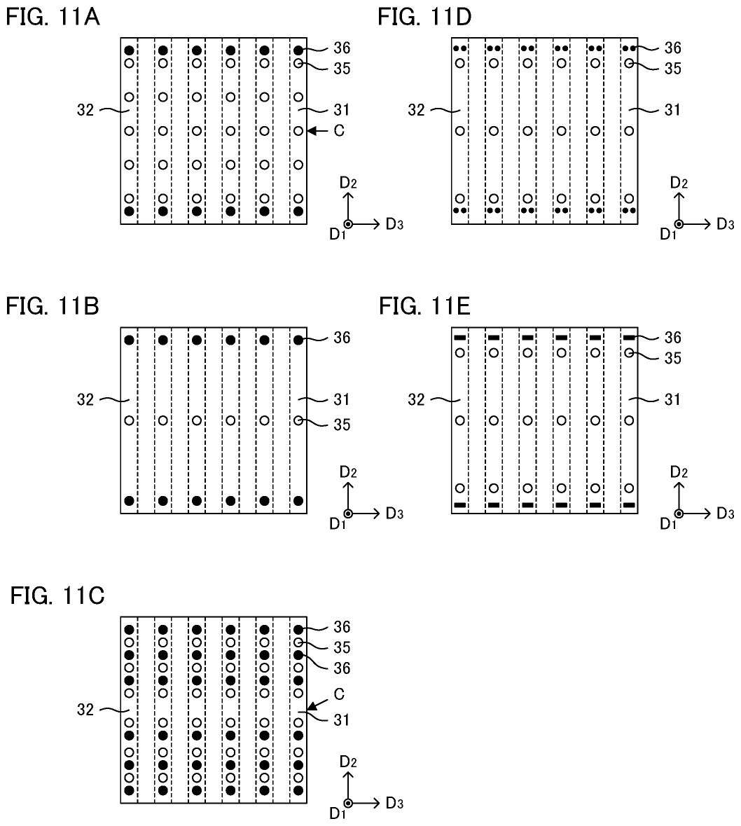

FIGS. 11A to 11E are schematic plan views exemplifying the fastening member and the fixing member in the first embodiment. In FIGS. 11A to 11E, the fixing member 36 is shown on the plate member 32 for convenience, similarly to FIG. 2B. As shown in FIGS. 11A to 11E, the fixing member 36 is preferably arranged in outer side than the fastening member 35 arranged in a position farthest from center C of the core member 31 in the second direction D₂, when viewed from the first direction D₁. Also, as shown in FIGS. 11A to 11E, it is preferable that the fixing member 36 is respectively arranged at both ends of one core member 31 in the second direction D₂.

As shown in FIG. 11A, a plurality of fastening member 35 may be arranged along the second direction D₂ in one core member 31. Also, in adjacent core members 31, adjacent fastening member 35 may be arranged along the third direction D₃. Also, as shown in FIG. 11B, one fastening member 35 may be arranged along the second direction D₂ in one core member 31.

As shown in FIG. 11C, it is preferable that the fixing member 36 is arranged in inner side than the fastening member 35 arranged in a position farthest from the center C of the core member 31 in the second direction D₂, when viewed from the first direction D₁. Also, as shown in FIG. 11C, the fastening member 35 and the fixing member 36 may be regularly arranged in the second direction D₂. In FIG. 11C, the fastening member 35 and the fixing member 36 are alternately arranged in the second direction D₂. Meanwhile, although not illustrated in particular, one or two or more of the fastening member and one or two or more of the fixing member may be alternately arranged in the second direction. Also, as shown in FIG. 11D, a plurality of the fixing member 36 may be arranged along the third direction D₃ in one core member 31, when viewed from the first direction D₁. Also, as shown in FIG. 11E, the shape of the fixing member 36 viewed from the first direction D₁ may be a square.

### 2. Battery

The battery module in the first embodiment includes a battery including a plurality of electrode layered in the first direction. Also, the electrode includes a current collector and an active material layer (cathode active material layer or anode active material layer) arranged on at least one surface of the current collector.

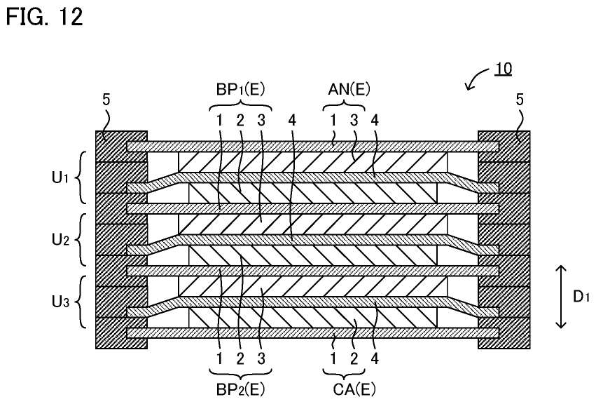

As shown in FIG. 12, battery 10 includes a plurality of electrode E layered in a first direction D₁. The battery 10 shown in FIG. 12 includes, as the electrode E, bipolar electrode BP₁, bipolar electrode BP₂, cathode side end electrode CA, and anode side end electrode AN. The bipolar electrode BP and the bipolar electrode BP₂ respectively include current collector 1, cathode active material layer 2 arranged on one surface of the current collector 1, and anode active material layer 3 arranged on the other surface of the current collector 1. The cathode side end electrode CA includes current collector 1, and cathode active material layer 2 arranged on one surface of the current collector 1. The anode side end electrode AN includes current collector 1, and anode active material layer 3 arranged on one surface of the current collector 1.

As shown in FIG. 12, the battery 10 may include, as the electrode E, a bipolar electrode BP including current collector 1, cathode active material layer 2 arranged on one surface of the current collector 1, and anode active material layer 3 arranged on the other surface of the current collector 1. The battery in the first embodiment may include just one of the bipolar electrode BP, and may include two or more thereof. Meanwhile, the battery in the first embodiment is not particularly limited if it includes a plurality of electrode layered in the first direction, and may not include the bipolar electrode.

As shown in FIG. 12, the battery 10 is provided with power generating unit U (U₁, U₂, U₃). The power generating unit U includes cathode active material layer 2, anode active material layer 3, and separator 4 arranged between the cathode active material layer 2 and the anode active material layer 3. The cathode active material layer 2, the anode active material layer 3, and the separator 4 are respectively impregnated with the liquid electrolyte (not illustrated). Also, the battery in the first embodiment may include one of the power generating unit, and may include two or more thereof.

As shown in FIG. 12, the battery 10 may include a plurality of power generating unit U (U₁, U₂, U₃) layered in the first direction D₁. As shown in FIG. 12, the plurality of power generating unit U (U₁, U₂, U₃) may be connected to each other in series. Also, although not illustrated in particular, the plurality of power generating units may be connected to each other in parallel. The plurality of power generating units are each independent so that the liquid electrolyte does not circulate to each other. In FIG. 12, the plurality of power generating unit U (U₁, U₂, U₃) is each independent so that the liquid electrolyte does not circulate to each other. For example, the power generating unit U₁ and the power generating unit U₂ are divided by the current collector 1 and the seal part 5, and thus are each independent.

As shown in FIG. 12, the seal part 5 in a frame shape is preferably arranged along the outer periphery of the current collector 1 when viewed from the first direction D₁. The seal part is preferably a resin. Examples of the resin may include a thermoplastic resin. Examples of the thermoplastic resin may include an olefin-based resin such as polyethylene and polypropylene.

The shape of the battery viewed from the first direction is not particularly limited, and examples thereof may include a square shape such as a foursquare and a rectangular. The length of each side configuring the outer periphery of the battery viewed from the first direction is, for example, 20 cm or more, may be 50 cm or more, and may be 100 cm or more. Meanwhile, the length of each side is, for example, 200 cm or less.

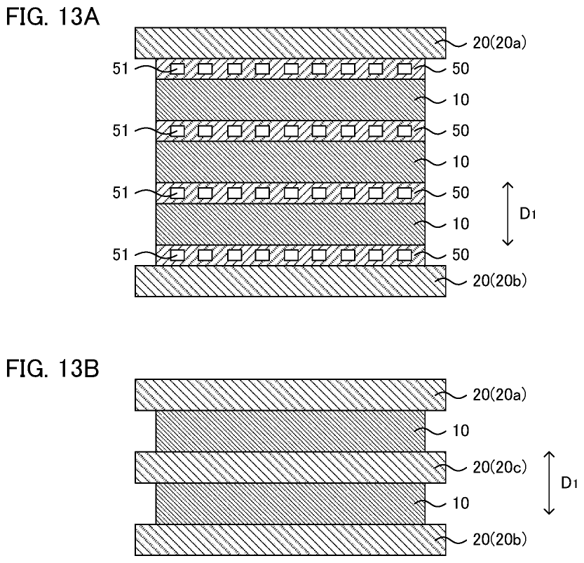

As shown in FIG. 13A, a plurality of battery 10 may be layered between a pair of the elastic member 20 (20a, 20b). In FIG. 13A, a plurality of battery 10 are layered interposing conductive plate 50 including path 51 in which a coolant circulates. Also, as shown in FIG. 13B, a plurality of battery 10 may be layered between a pair of the elastic member 20 (20a, 20b), and elastic member 20c may be arranged between the battery 10 adjacent to each other.

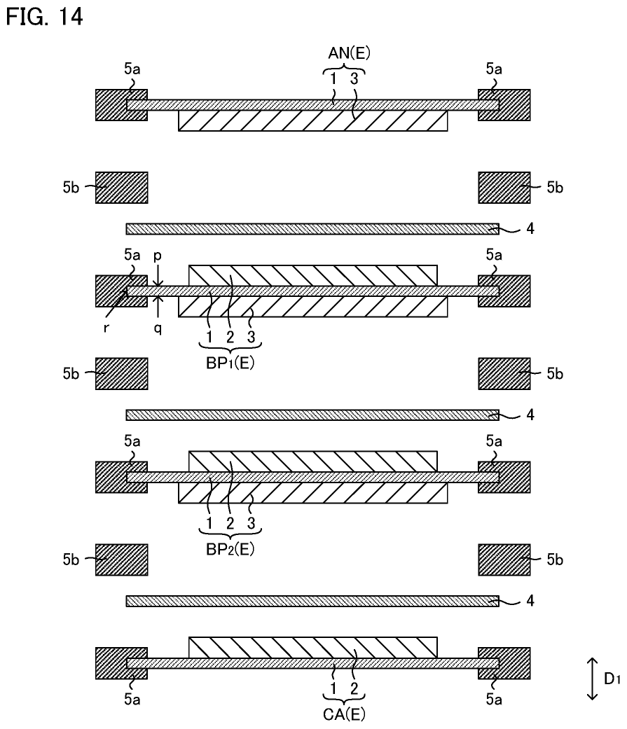

There are no particular limitations on the method for producing the battery. FIG. 14 is a schematic cross-sectional view (exploded view) exemplifying the method for producing the battery in the first embodiment. As shown in FIG. 14, bipolar electrode BP₁ and bipolar electrode BP₂ are prepared. The bipolar electrode BP₁ includes cathode active material layer 2 arranged on one surface of current collector 1, and anode active material layer 3 arranged on the other surface of the current collector 1.

Further, the bipolar electrode BP₁ includes frame member 5a for forming seal part, arranged along with the outer periphery of the current collector 1. When viewed from the first direction D₁, the frame member 5a is usually arranged along with the entire outer periphery of the current collector 1. For example, when the shape of the outer periphery of the current collector 1 is a square, the frame member 5a is arranged along with the entire outer periphery of that square. Also, as shown in FIG. 14, the frame member 5a usually covers a part of one main surface p of the current collector 1, a part of the other main surface q of the current collector 1, and the whole of side surface r configuring the outer periphery of the current collector 1.

As shown in FIG. 14, the bipolar electrode BP₂ includes cathode active material layer 2 arranged on one surface of current collector 1, and anode active material layer 3 arranged on the other surface of the current collector 1. Further, the bipolar electrode BP₂ includes frame member 5a for forming seal part, arranged along with the outer periphery of the current collector 1. The details of the bipolar electrode BP₂ are the same as the details of the bipolar electrode BP₁ described above.

As shown in FIG. 14, the anode active material layer 3 in the bipolar electrode BP₁ and the cathode active material layer 2 in the bipolar electrode BP₂ are faced to each other interposing separator 4. On this occasion, at least a part of the outer periphery of the separator 4 is arranged between the frame member 5a adjacent to each other. Also, frame member (spacer) 5b is arranged between the frame member 5a in the bipolar electrode BP₁ and the frame member 5a in the bipolar electrode BP₂. Next, the cathode side end electrode CA is layered on the bipolar electrode BP₂ interposing the separator 4, and the anode side end electrode AN is layered on the bipolar electrode BP₁ interposing the separator 4. After that, a plurality of frame members layered are welded to form the seal part. Also, although not illustrated in particular, when each electrode is layered, by arranging a nest between the frame members adjacent to each other and pulling out the nest after forming the seal part, a supplying hole for supplying a liquid electrolyte is formed. The liquid electrolyte is supplied into the battery from the supplying hole, and then the supplying hole is sealed. Thereby, the battery is obtained.

### 3. Elastic Member

The battery module in the first embodiment includes a pair of elastic member arranged on both surfaces of the battery. The elastic member and the battery may contact each other, and may be layered interposing another member.

Examples of the material of the elastic member may include a polymer material. Examples of the polymer material may include a silicone rubber, a fluorine rubber, a epichlorohydrin rubber, an acrylic rubber, an ethylene acrylic rubber, an urethane rubber, a nitrile rubber, a hydrogenated nitrile rubber, a chlorosulfonated polyethylene, a chloroprene rubber, an EPDM (ethylene-propylene-diene rubber), an ethylene rubber, a propylene rubber, a butyl rubber, a butadiene rubber, a styrene butadiene rubber, a natural rubber, polyisobutylene, a chlorinated polyethylene, an isoprene rubber, a polypropylene foam, a polyethylene foam, and a polyurethane foam. Also, examples of the shape of the elastic member may include a layer shape and a porous shape. Also, the thickness of the elastic member is not particularly limited, and for example, it is 1 mm or more and 5 cm or less.

### 4. Restraining Member

The restraining member in the first embodiment is a restraining member that applies a restraining pressure to the battery, the pair of elastic member and the pair of plate member in the first direction, and a pair of the restraining member is arranged to face to each other in a second direction orthogonal to the first direction.

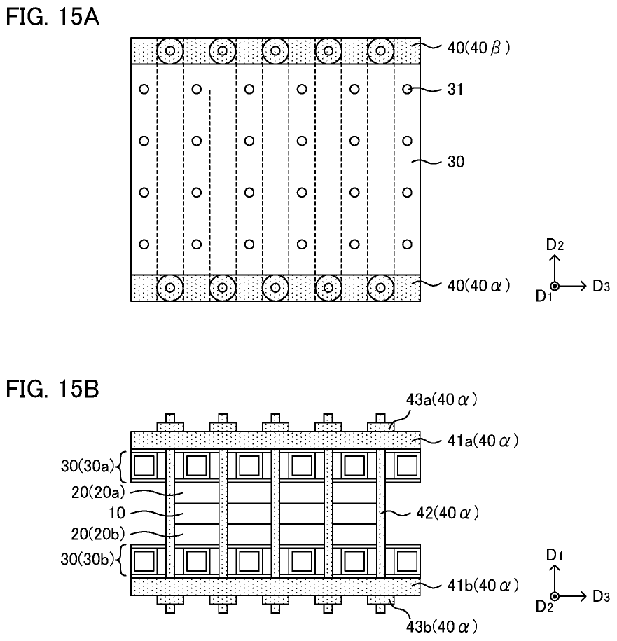

As shown FIGS. 15A and 15B, the restraining member 40 is a member that applies a restraining pressure to the battery 10, a pair of elastic member 20 (20a, 20b), and a pair of plate member 30 (30a, 30b) in the first direction D₁. Also, as shown in FIG. 15A, a pair of restraining member 40 (40α, 40β) is arranged to face to each other in the second direction D₂. Also, when viewed from the first direction D₁, the pair of restraining member 40 (40α, 40β) is arranged in a position overlapping with the plate member 30.

As shown in FIG. 15B, the restraining member 40α may include: first restraining plate 41a that is arranged on a surface of the plate member 30a opposite to the elastic member 20a side, and extends to the third direction D₃; second restraining plate 41b that is arranged on a surface of the plate member 30b opposite to the elastic member 20b side, and extends to the third direction D₃; connecting member 42 that connects the first restraining plate 41a and the second restraining plate 41b; and adjusting member 43 (43a, 43b) that is connected to the connecting member 42 and adjusts a distance between the first restraining plate 41a and the second restraining plate 41b. Also, the restraining member 40β preferably has the same structure as that of the restraining member 40α.

The restraining pressure to be applied by the restraining member is, for example, 10 kN or more and 500 kN or less, and may be 20 kN or more and 400 kN or less.

### 5. Battery Module

Examples of the applications of the battery module in the first embodiment may include a power source for vehicles such as hybrid electric vehicles (HEV), plug-in hybrid electric vehicles (PHEV), battery electric vehicles (BEV), gasoline-fueled automobiles and diesel powered automobiles. In particular, it is preferably used as a power source for driving hybrid electric vehicles (HEV), plug-in hybrid electric vehicles (PHEV), and battery electric vehicles (BEV). Also, the battery module in the first embodiment may be used as a power source for moving bodies other than vehicles (such as rail road transportation, vessel and airplane), and may be used as a power source for electronic products such as information processing equipment.

### B. Second Embodiment

The battery module in the second embodiment is a battery module comprising: a battery including a plurality of electrode layered in a first direction; a pair of elastic member arranged on both surfaces of the battery; a pair of plate member arranged to sandwich the battery and the pair of elastic member in the first direction; and a restraining member that applies a restraining pressure to the battery, the pair of elastic member and the pair of plate member in the first direction, and a pair of the restraining member is arranged to face to each other in a second direction orthogonal to the first direction, wherein the plate member includes a plurality of core member extending to the second direction, and a first plate member arranged on a surface of the plurality of core member that is the battery side; in the plate member, the core member and the first plate member include a penetration hole extending to the first direction, and the core member and the first plate member are fastened in the first direction by a first fastening member arranged in the penetration hole; when viewed from the first direction, the plate member includes a first fixing member that: is arranged in inner side than the outer periphery of the core member; and limits relative movement of the core member and the first plate member to the second direction; and the first fixing member has higher strength in the second direction compared to that of the first fastening member.

According to the second embodiment, the specified fixing member (fixing member with higher strength in the second direction than that of the fastening member) is arranged in the plate member including the core member and the plate member, and thus the battery module may have high uniformity in restraining pressure to be applied to the battery. Also, the fixing member in the second embodiment may be a member that fastens the core member and the plate member in the first direction. Meanwhile, the fixing member in the second embodiment may be a member that does not fasten the core member and the plate member in the first direction. The details of each member configuring the battery module are in the same contents as those described in “A. First embodiment” above; thus, the descriptions herein are omitted.

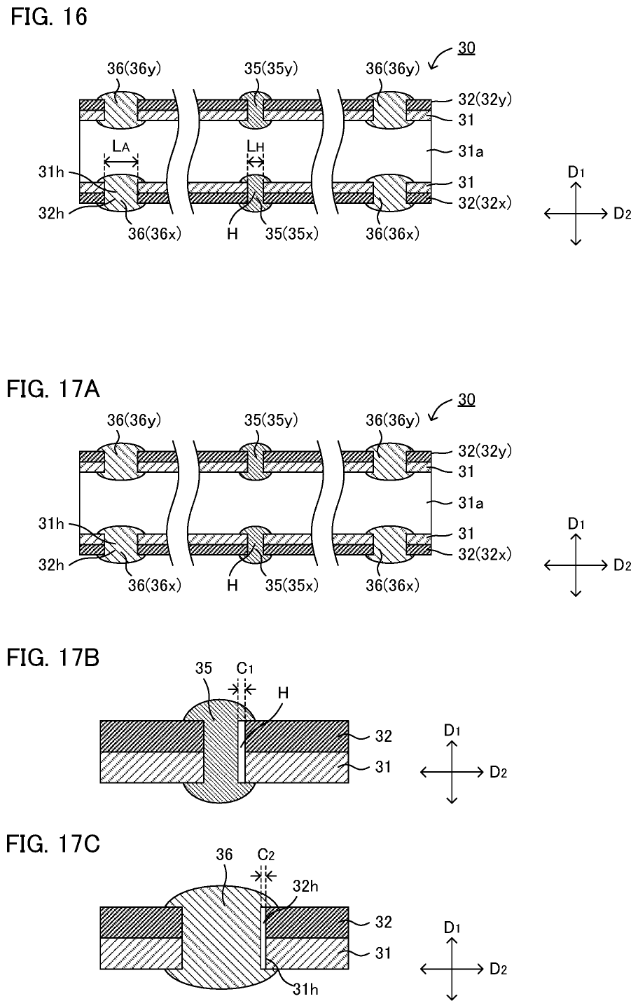

FIG. 16 is a schematic cross-sectional view of the plate member in a plane of D₁-D₂ including X-X line shown in FIG. 2B, similarly to FIG. 2C. As shown in FIG. 16, in the second embodiment, the strength of the fixing member 36 is higher than that of the fastening member 35 in the second direction Dz. “The strength in the second direction is high” means that the shearing strength in the second direction is high. For example, the material (typically a metal) used for the fixing member 36 may have higher shearing strength than that of the material (typically a metal) used for the fastening member 35. Also, as shown in FIG. 16, L_{H} designates a length in the second direction D₂ of the penetration hole H configured to arrange the fastening member 35, and LA designates a length in the second direction D₂ of hole part 31h formed in the core member 31 and the hole part 32h formed in the plate member 32. The LA is preferably larger than the L_{H}. The rate of the LA with respect to the L_{H}, which LA/L_{H} is, for example, 1.2 or more, may be 1.5 or more, and may be 3 or more. Meanwhile, the LA/L_{H} is, for example, 5 or less.

### C. Third Embodiment

The battery module in the third embodiment is a battery module comprising: a battery including a plurality of electrode layered in a first direction; a pair of elastic member arranged on both surfaces of the battery; a pair of plate member arranged to sandwich the battery and the pair of elastic member in the first direction; and a restraining member that applies a restraining pressure to the battery, the pair of elastic member and the pair of plate member in the first direction, and a pair of the restraining member is arranged to face to each other in a second direction orthogonal to the first direction, wherein the plate member includes a plurality of core member extending to the second direction, and a first plate member arranged on a surface of the plurality of core member that is the battery side; in the plate member, the core member and the first plate member include a penetration hole extending to the first direction, and the core member and the first plate member are fastened in the first direction by a first fastening member arranged in the penetration hole; when viewed from the first direction, the plate member includes a first fixing member that: is arranged in inner side than the outer periphery of the core member; and limits relative movement of the core member and the first plate member to the second direction; and a clearance between the first fixing member and a side surface of a hole part formed in the core member and the first plate member in the second direction is smaller than a clearance between the first fastening member and a side surface of the penetration hole in the second direction.

According to the third embodiment, the specified fixing member (a clearance between the fixing member and a side surface of a hole part formed in the core member and the plate member in the second direction is smaller than a clearance between the fastening member and a side surface of the penetration hole in the second direction) is arranged on the plate member including the core member and the plate member, the battery module may have high uniformity in the restraining pressure applied to the battery. Also, the fixing member in the third embodiment may be a member that fastens the core member and the plate member in the first direction. Meanwhile, the fixing member in the third embodiment may be a member that does not fasten the core member and the plate member in the first direction. Also, the fixing member in the third embodiment may have higher strength in the second direction than that of the fastening member. Details of each member configuring the battery module are the same as those described in “A. First embodiment” above and “B. Second embodiment” above; thus, the descriptions herein are omitted.

FIG. 17A is a schematic cross-sectional view of the plate member in a plane of D₁-D₂ including X-X line shown in FIG. 2B, similarly to FIG. 2C. FIGS. 17B and 17C are the enlarged views enlarging the fastening member 35 and the fixing member 36 in FIG. 17A. As shown in FIGS. 17B and 17C, in the third embodiment, clearance C₂ between the fixing member 36 and a side surface of hole parts (hole part 31h and hole part 32h) formed in the core member 31 and the plate member 32 in the second direction D₂ is smaller than clearance C₁ between the fastening member 35 and a side surface of the penetration hole H in the second direction D₂. The rate of the C₂ with respect to the C₁, which is C₂/C₁ is, for example, 0.8 or less, and may be 0.6 or less. Meanwhile, the C₂/C₁ is, for example, 0.3 or more.

The present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### REFERENCE SINGS LIST

1 current collector
2 cathode active material layer
3 anode active material layer
4 separator
5 seal part
10 battery
20 elastic member
30 plate member
31 core member
32 plate member
35 fastening member
36 fixing member
40 restraining member
50 conductive plate
100 battery module

What is claimed is:

1. A battery module comprising:
a battery including a plurality of electrode layered in a first direction;
a pair of elastic member arranged on both surfaces of the battery;
a pair of plate member arranged to sandwich the battery and the pair of elastic member in the first direction; and
a restraining member that applies a restraining pressure to the battery, the pair of elastic member and the pair of plate member in the first direction, and a pair of the restraining member is arranged to face to each other in a second direction orthogonal to the first direction, wherein
the plate member includes a plurality of core member extending to the second direction, and a first plate member arranged on a surface of the plurality of core member that is the battery side;
in the plate member, the core member and the first plate member include a penetration hole extending to the first direction, and the core member and the first plate member are fastened in the first direction by a first fastening member arranged in the penetration hole; and
when viewed from the first direction, the plate member includes a first fixing member that: is arranged in inner side than the outer periphery of the core member; limits relative movement of the core member and the first plate member to the second direction; and does not fasten the core member and the first plate member in the first direction.

2. A battery module comprising:
a battery including a plurality of electrode layered in a first direction;
a pair of elastic member arranged on both surfaces of the battery;
a pair of plate member arranged to sandwich the battery and the pair of elastic member in the first direction; and
a restraining member that applies a restraining pressure to the battery, the pair of elastic member and the pair of plate member in the first direction, and a pair of the restraining member is arranged to face to each other in a second direction orthogonal to the first direction, wherein
the plate member includes a plurality of core member extending to the second direction, and a first plate member arranged on a surface of the plurality of core member that is the battery side;
in the plate member, the core member and the first plate member include a penetration hole extending to the first direction, and the core member and the first plate member are fastened in the first direction by a first fastening member arranged in the penetration hole;
when viewed from the first direction, the plate member includes a first fixing member that: is arranged in inner side than the outer periphery of the core member; and limits relative movement of the core member and the first plate member to the second direction; and
the first fixing member has higher strength in the second direction compared to that of the first fastening member.

3. A battery module comprising:
a battery including a plurality of electrode layered in a first direction;
a pair of elastic member arranged on both surfaces of the battery;
a pair of plate member arranged to sandwich the battery and the pair of elastic member in the first direction; and
a restraining member that applies a restraining pressure to the battery, the pair of elastic member and the pair of plate member in the first direction, and a pair of the restraining member is arranged to face to each other in a second direction orthogonal to the first direction, wherein
the plate member includes a plurality of core member extending to the second direction, and a first plate member arranged on a surface of the plurality of core member that is the battery side;
in the plate member, the core member and the first plate member include a penetration hole extending to the first direction, and the core member and the first plate member are fastened in the first direction by a first fastening member arranged in the penetration hole;
when viewed from the first direction, the plate member includes a first fixing member that: is arranged in inner side than the outer periphery of the core member; and limits relative movement of the core member and the first plate member to the second direction; and
a clearance between the first fixing member and a side surface of a hole part formed in the core member and the first plate member in the second direction is smaller than a clearance between the first fastening member and a side surface of the penetration hole in the second direction.

4. The battery module according to claim 1, wherein the first fixing member is arranged to overlap with a boundary between the core member and the first plate member when viewed from the second direction.

5. The battery module according to claim 1, wherein the first fixing member fits each of a hole part formed in the core member and a hole part formed in the first plate member to limit relative movement of the core member and the first plate member to the second direction.

6. The battery module according to claim 1, wherein
the plate member includes a second plate member arranged on a surface of the plurality of core member that is opposite side to the battery;
in the plate member, the core member and the second plate member include a penetration hole extending to the first direction, and the core member and the second plate member are fastened in the first direction by a second fastening member arranged in the penetration hole; and
when viewed from the first direction, the plate member includes a second fixing member that: is arranged in inner side than the outer periphery of the core member; limits relative movement of the core member and the second plate member to the second direction; and does not fasten the core member and the second plate member in the first direction.

7. The battery module according to claim 1, wherein the first fixing member is arranged in outer side than the first fastening member arranged in a position farthest from a center of the core member in the second direction, when viewed from the first direction.

8. The battery module according to claim 1, wherein a first fixing member is respectively arranged at both ends of one of the core member in the second direction.

9. The battery module according to claim 1, wherein the core member is a hollow member including a hollow part extending to the second direction.

10. The battery module according to claim 1, wherein a shape of an outer periphery of the core member when viewed from the second direction is a square.

11. The battery module according to claim 1, wherein, in the plate member, the core members adjacent to each other are arranged interposing a space in a third direction orthogonal to the first direction and the second direction.

12. The battery module according to claim 1, wherein a shape of the battery when viewed from the first direction is a square, and a length of each side configuring the square is 20 cm or more.

13. The battery module according to claim 1, wherein the restraining pressure to be applied by the restraining member is 10 kN or more and 500 kN or less.
